(19) United States
(12) Patent Application Publication
(10) Pub. No.: US 2007/0226606 A1
(43) Pub. Date: Sep. 27, 2007

(54) Method of processing annotations using filter conditions to accentuate the visual representations of a subset of annotations

(76) Inventors: Peter Noyes, Pasadena, CA (US); Benjamin Gunderson, Simi Valley, CA (US)

Correspondence Address: STETINA BRUNDA GARRED & BRUCKER, 75 ENTERPRISE, SUITE 250, ALISO VIEJO, CA, 92656, US

(21) Appl. No.: 11/389,973

(22) Filed: Mar. 27, 2006

(51) Int. Cl. G06F 15/00

(52) U.S. Cl. 715/512

(57) ABSTRACT

A method of processing annotations is provided in accordance with an aspect of the present invention. The method includes the step of loading a plurality of annotations into a memory, each annotation being defined by properties. The method includes the step of displaying in a workspace window a first visual representation of each of the annotations. The method includes the step of receiving a filter command which specifies a condition which may be operative to derive an included annotation set and an excluded annotation set. The method includes deriving a second visual representation of each of the annotations of the excluded annotation set different from the first visual representations of the annotations of the excluded annotation set.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention generally relates to methods for processing annotations appended to a document, and more particularly, to methods for accentuating a subset of the annotations.

2. Related Art

With the advancement of high speed data communications, commerce and industry have come to rely upon the same to enable individuals in distant locations to collaborate. While real-time collaboration using video conferencing and the like are becoming increasingly employed, the vast majority of collaboration occurs over e-mail and the exchange of documents incorporating incremental changes transmitted thereby. Due to the existence of many different computer platforms having a variety of operating systems, application programs, and processing and graphics display capabilities, it was appreciated by those in the art that a device-independent, resolution-independent file format was necessary to facilitate such exchange. In response to these needs, the Portable Document Format (PDF), among other competing formats, was developed.

The PDF standard is a combination of a number of technologies, including a simplified PostScript interpreter subsystem, a font embedding subsystem, and a storage subsystem. As practitioners in the art will recognize, PostScript is a page description language for generating the layout and the graphics of the document. Further, per the requirements of the PDF storage subsystem, all elements of the document, including text, vector graphics, and raster (bitmap) graphics, collectively referred to herein as graphic elements, are encapsulated into a single file. The graphic elements are not encoded to a specific operating system, software application, or hardware, but are designed to be rendered in the same manner regardless of destination or origin. The cross-platform capability of PDF aided in its widespread adoption, and is now a de facto standard for document exchange. Currently, PDF is utilized to encode a wide variety of documents types, including those largely composed of text and those largely composed of vector and raster graphics. Due to its versatility and universality, files in the PDF format are often preferred over more particularized file formats of specific word processing applications, illustration applications, CAD applications, and the like.

A number of useful improvements have been made since the initial releases of PDF readers, writers, and the standard. One improvement, particularly with regard to collaboration technologies, was the capability of adding graphical annotations to a base document. For example, a local user created an initial version of the document, and transmitted it to distant colleagues. These remote users added their comments in the form of the annotations, and transmitted the newly annotated version of the document back to the local user. Upon making the changes as suggested by the colleagues, the local user again revised the document and transmitted the same back to the distant users. Other workflows were possible, such as where the base document ascends an organizational hierarchy, ascension of each step involving the addition of annotations by the respective recipients of the document. It is noted that PDF was not the only format incorporating collaboration features, and files generated by word processors such as MICROSOFT WORD also included the capacity to add annotations and differentiate between changes made to a document. However, as practitioners in the art will appreciate, the annotation capabilities related to PDF offered the greatest degree of flexibility because of the particulars relating to the structuring of the data.

It will also be appreciated that in the course of these electronic document exchanges, numerous annotations will accumulate, leading to problems related to its management. The annotations and the document were rendered at once on a primary window, and numerous annotations placed thereon often cluttered the view, making it difficult to derive any meaningful understanding of the same.

One proposed solution to efficiently track all of the annotations placed on the document was the use of a secondary window for displaying a list of annotations organized according to a description thereof. By default, the list was grouped according to the page on which the annotation was located. However, the list could be re-organized according to a number of predefined properties such as the aforementioned page location via a pull-down menu, in which like annotations having the selected predefined property would be displayed in close proximity to each other. Selecting a representation of a given annotation in the secondary window was operative to move the focus of the screen such that selected annotation appeared in the center of the primary window.

While the technique utilized above provided some measure of organization to the annotations placed on the document, there still remained a number of deficiencies. One such deficiency was that the view of the document and its annotations on the primary window remained cluttered, and a comprehensible view of and navigation between the annotations were unavailable. More particularly, it was necessary for the user to scroll through each of the annotations in the listing individually without gaining an understanding of the context of each annotation in relation to another. Accordingly, there is a need in the art for an improved method for processing annotations.

### BRIEF SUMMARY

According to an aspect of the present invention, there is provided a method of processing annotations associated with a document. The document may have graphic elements overlaid on a background, with the document and each of the annotations capable of being displayed on an output device. The output device may be associated with a data processing device that includes a memory. The method further includes the step of loading a plurality of annotations into the memory, while each annotation may be defined by properties. The method also includes the step of displaying in a workspace window a first visual representation of each of the annotations as defined by the properties. The method includes the step of displaying in a markup window a catalog having entries descriptive of the annotations loaded in memory, the entries depicting values of the properties defining the annotations. The method also includes the step of receiving a filter command which specifies a condition, the filter command being operative to derive an included annotation set and an excluded annotation set. Additionally, multiple sub-conditions may comprise the condition. The included annotation set may be defined by those annotations with properties matching the condition. The excluded annotation set may be the plurality of annotations less the included annotations. The method may further include the step of deriving a second visual representation of the each of the annotations of the excluded annotation set different from the first visual representations of the annotations of the excluded annotation set. The method may also include the step of displaying in the workspace window each of the second visual representations of the annotations of the excluded annotation set.

In accordance with another aspect of the present invention the method may further comprise the step of refreshing the markup window with the entries descriptive of the annotations of the excluded annotation set being removed from the catalog. At least one of the properties defining the annotations may be an appearance type property. The appearance type property may have a first value while displaying the first visual representation of the annotation of the excluded annotation set. The deriving step may further include the step of transforming the first value of the appearance type property into a second value.

According to various embodiments, the method may also include the step of generating a corresponding grayscale representation of the graphic elements, in which the grayscale representation includes a brightness component. The method may further include the step of modifying the brightness component of the grayscale representation to fade the grayscale representation of the graphic elements into the background.

According to yet another aspect of the present invention, the method may further include the step of deriving a second visual representation of each of the annotations of the included annotation set different from the first visual representation of each of the annotations of the included annotation set. The method may also include the step of displaying in the workspace window each of the second visual representations of the annotations of the included annotation set.

In accordance with another embodiment, at least one of the properties defining the annotations may be an appearance type property. There may be a first appearance type property defining each of the annotations of the excluded annotation set, and a second appearance type property defining each of the annotations of the included annotation set. Further, the first appearance type property may have an initial first value while displaying the first visual representation of the respective annotation of the excluded annotation set.

According to still another aspect of the present invention, the step of deriving the second visual appearance of the respective annotation of the excluded annotation set may further include the step of transforming the initial first value into a resultant first value. Moreover, the second appearance property may have an initial second value while displaying the first visual representation of the respective annotation of the included annotation set. The step of deriving the second visual appearance of the respective annotation of the included annotation set may further include the step of transforming the initial second value into a resultant second value. The transforming step of the initial first Value may be different from the transforming step of the initial second value. The first appearance type property may define a color, and the initial first value may be representative of the color. The transforming step of the initial first value possibly include the steps of converting the initial first value of the color to a corresponding grayscale value and adjusting the grayscale value to a resultant first value. The resultant first value may be preset, and the grayscale value may be adjusted by a preset number.

According to another aspect of the present invention, the method may include the steps of grouping the entries of the catalog according to one of the properties of the respective one of the annotations loaded in the memory. The method may also include the step of generating a grouping header in the catalog, the grouping header being representative of one of the properties of the annotation by which the entries are being grouped. The catalog may be a table having a plurality of rows and columns, each column being related to one of the properties of the annotations and each row being related to one of the annotations. The table may include a column header for each column, and a first column header being descriptive of the property contained in a first column. The method may further include the step of displaying in the vicinity of the first column header a first value selection window including a first listing having first elements representative of each of the values of the property contained in the first column. The filter command may be triggered by a selection of one of the first elements of the first listing, the first value of the selected first element being a first sub-condition comprising the condition by which the included annotation set is defined. Furthermore, the second column header may be descriptive of the property contained in a second column. The method may further include the step of displaying in the vicinity of the second column header a second value selection window including a second listing having second elements representative of each of the values of the property contained in the second column. The filter command may be triggered by a selection of one of the second elements of the second listing, the second value of the selected second element being a second sub-condition comprising the condition by which the included annotation set is defined, the first sub-condition and second sub-condition being combined to form the condition.

Further in accordance with still another aspect of the present invention, there is provided a method of using a graphical computer application. The method may include the step of placing a plurality of annotations on a workspace window, each of the annotations being defined by properties and having a first visual appearance. The method may also include the step of invoking a filter command on a markup window to specify a condition. The filter command may be operative to derive an included annotation set and an excluded annotation set. The included annotation set may be defined by those annotations with properties matching the condition. The excluded annotation set may be the plurality of annotations less the included annotations. The filter command may be operative to display a second visual representation of each of the annotations of the excluded annotation set different from the first visual representations of the annotations of the excluded annotation set. The filter command may also be operative to display a second visual representation of the annotations of the included annotation set different from the first visual representation of each of the annotations of the included annotation set.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an exemplary computer system that may be capable to perform functions for use with aspects of the present invention;

FIG. 2 is a block diagram of system components of the exemplary computer system of FIG. 1;

FIG. 3 shows an exemplary output of the computer program capable of performing the methodology of the present invention, including a menu bar, a tool bar, a workspace window, a markup window, and a property window;

FIG. 4 is a flowchart illustrating the steps of processing annotations and using a graphical computer application in accordance with an aspect of the present invention;

FIG. 5 is a tree diagram illustrating the categories and hierarchical organization of properties relating to an annotation;

FIG. 6 is an exemplary output after adding a second annotation, demonstrating the grouping functionality;

FIG. 7 is an exemplary output after adding a third annotation, further demonstrating another aspect of the grouping functionality;

FIG. 8 is an exemplary output after adding a fourth annotation;

FIG. 9 is an exemplary output showing the functionality of a filter command including an overlaid selection window; and

FIG. 10 is an exemplary output following the results of the filter command.

### DETAILED DESCRIPTION

The detailed description set forth below in connection with the appended drawings is intended as a description of the presently preferred embodiment of the invention, and is not intended to represent the only form in which the present invention may be developed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first, second, and the like are used solely to distinguish one from another entity without necessarily requiring or implying any actual such relationship or order between such entities.

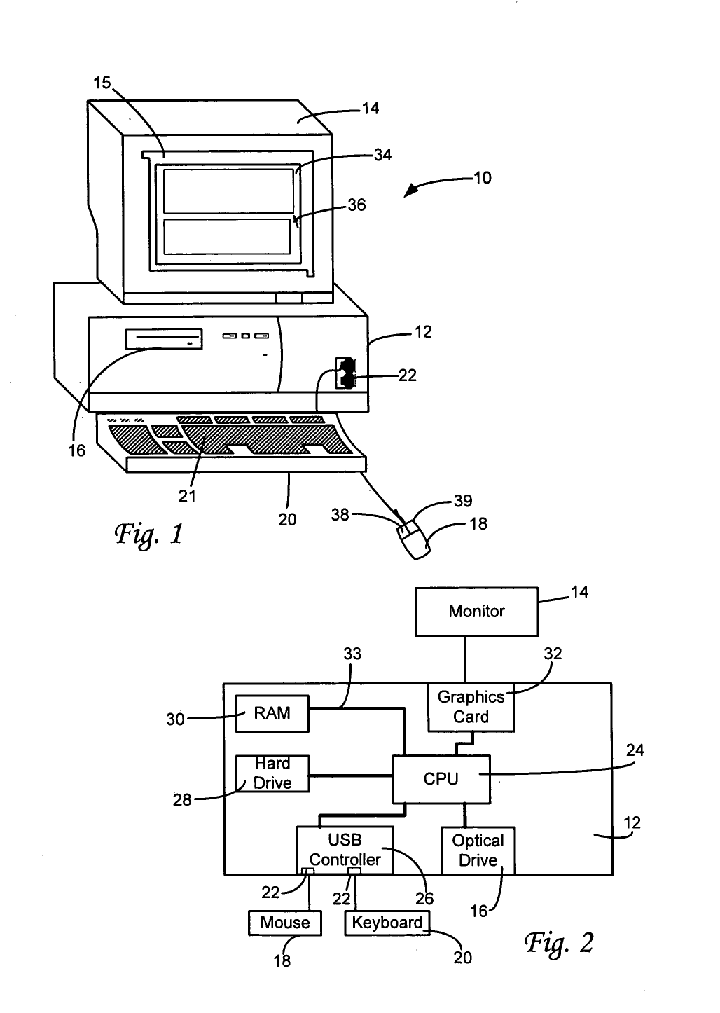

With reference now to FIG. 1, an exemplary hardware environment capable for use with the present invention is shown as an exemplary computer system 10. The computer system 10 includes a central computer 12 with an attached monitor 14 for graphically displaying output of the central computer 12. An optical drive 16 may also be included, as well as and any number of input devices such as a mouse 18 and a keyboard 20. Further, additional input devices such as a graphical tablet (not shown) may also be attached to the central computer 12. Typically, such input devices are connected to the central computer 12 through a USB port 22, however, alternative interconnects such as a PS/2 port or a RS-232 serial port is also contemplated.

Further details of the exemplary computer system 10 are shown in FIG. 2 as a block diagram, with the central computer 12 including a central processing unit (CPU) 24 receiving input from the mouse 18 and the keyboard 20 through the USB port 22. The USB port 22 is connected to a USB controller 26, which processes the signals from the mouse 18 and the keyboard 20 and forms packets of data to be transmitted to the CPU 24. Furthermore, the central computer 12 includes a hard drive 28 for long term storage of data, a random access memory (RAM) 30 for short term storage of data, and the optical drive 16 for permanent storage or input of data. The optical drive 16 may be a CD-ROM drive, CD-R drive, CD-RW drive, DVD-ROM drive, and so forth. Output from the CPU 24 is further processed by a graphics card 32, which transmits signals to the monitor 14. The optical drive 16, the USB controller 26, the hard drive 28, the RAM or memory 30, and the graphics card 32 are in electrical communication with the CPU 24 via interconnects 33 which may be included in a motherboard disposed within the central computer 12. The results of the data processing operation as carried out by the CPU 24 are displayed as graphics on the screen 15 of the monitor 14. It will be understood that any type of monitor 14, such as a Cathode Ray Tube (CRT), Liquid Crystal Display (LCD) or any other suitable output device may be substituted.

The computer system 10 may utilize any operating system having a graphical user interface (GUI), such as MICROSOFT WINDOWS®, APPLE MACOS®, UNIX operating systems utilizing X Windows, and so forth. The central computer 12 executes one or more computer programs, a resulting first output 34 of such computer program being displayed as “windows” or screen interfaces on the screen 15 as in FIG. 1.

Generally, the operating system and the computer programs are tangibly embodied in a computer-readable medium, e.g. one or more of the fixed and or removable data storage devices including the hard drive 28 or optical media read by the optical drive 16. Both the operating system and the computer programs may be loaded from the aforementioned data storage devices into the RAM 30 for execution by the CPU 24, and comprise instructions which, when read and executed by the CPU 24, causes the central computer 12 to perform the steps necessary to execute the steps or features of the present invention.

With regards to the interaction between a user and the computer system 10, a cursor 36 is directed via the mouse 18 to locations within the screen 15 having interactive elements, the details of which will be described more fully below. The mouse 18 may include a left mouse button 38 and a right mouse button 39. A data processing procedure may be initiated by the user activating such interactive elements through clicking the mouse buttons 38, 39 while cursor 36 is positioned on or near the interactive element. Additionally, a key 21 on the keyboard 20 may be pressed to initiate another data processing procedure.

It will also be understood by a person having ordinary skill in the art that while the following description of the invention refers to steps carried out in an exemplary computer system 10, any other data processing device having similar functionality may be used without departing from the scope of the invention. Moreover, while the following description of the invention refers to “clicking” the left or right mouse buttons 38 or 39, “positioning” the cursor 36 within the monitor 14, and so forth, it will be understood that these terms refer to any similar user interaction with the computer system 10 through a graphical user interface.

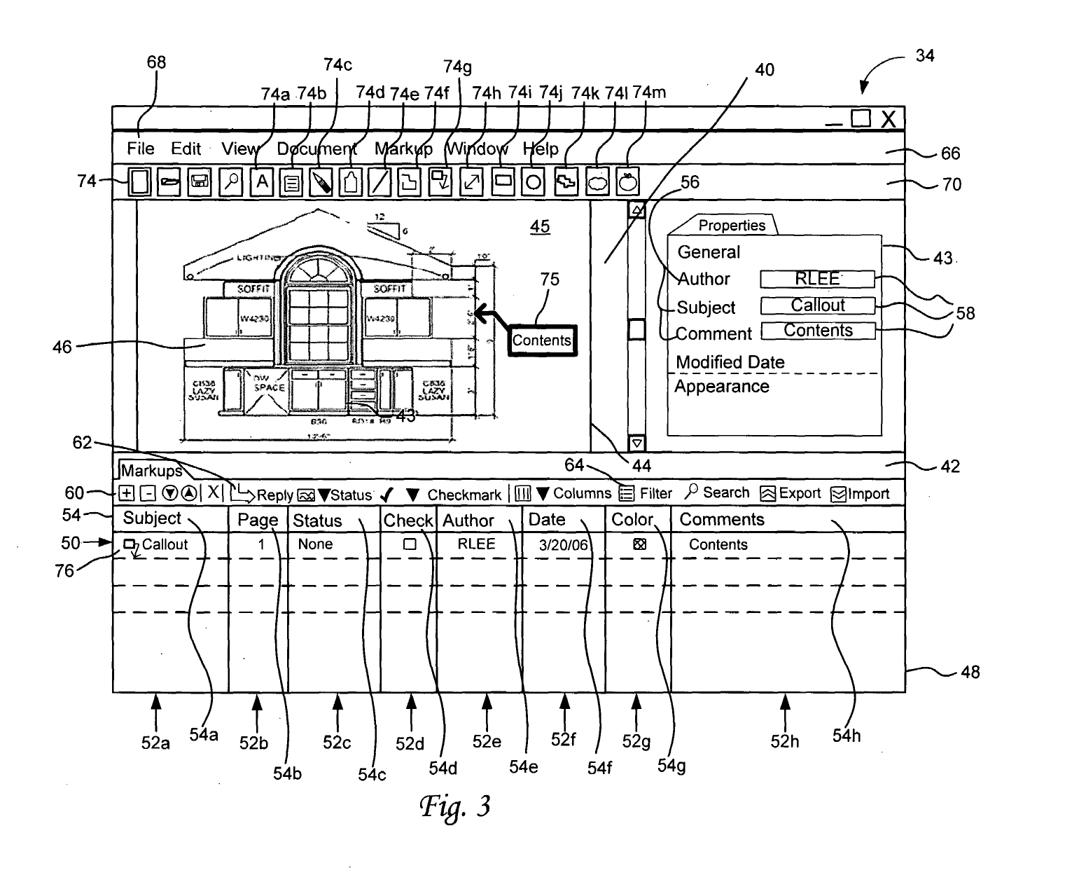

In accordance with an aspect of the present invention, there is provided a method of processing annotations associated with a document. With reference to FIG. 3, the first output 34 of a computer program capable of performing the method of the present invention is shown. The first output 34 is generally divided into a workspace window 40, a markup window 42, and a properties window 43.

Displayed in the workspace window 40 is a document 44 having graphical elements 46 overlaid on a background 45. In a preferred embodiment, the document 44 is a PDF file, but one of ordinary skill in the art will recognize that any file format capable of embedding data in addition to data related to the base document may be substituted without departing from the scope of the present invention. As described above in relation to the background of PDF technology, the graphical elements 46 may be text, vector graphics, or raster graphics. As used herein, the term graphical elements 46 may refer to all three of these types of data. Depending on the encoding and structure within the document 44, the graphical elements 46 may or may not be editable from the workspace window 40.

The markup window 42 is positioned under the workspace window 40, and includes a table 48 having rows 50 and columns 52a-52h, each including column headers 54a-54h. For the sake of simplicity, when referring generally to all of columns 52a-52h or to all of column headers 54a-54h, reference will be made to columns 52 or column headers 54, respectively. The manipulation of the contents thereof will be described in further detail below. There is provided a markup window toolbar 60 including markup function icons 62 operative to initiate a data processing procedure when clicked. Based on the descriptions of the respective markup function icons 62, one of ordinary skill will understand the basic nature of the procedures which can be initiated. For example, clicking the “search” icon with the magnifying glass will activate a search window for inputting search queries. Details relating to the data processing procedures initiated by clicking a filter icon 64, however, will be discussed in further detail below. The properties window 43 may be positioned to the right of the workspace window 40 as shown, or at any suitable location. The properties window 43 may include property descriptors 56 and corresponding input boxes 58 for entering values relating to the property descriptors 56.

The first output 34 of the computer program may also have a menu bar 66 including menu bar descriptions 68. The menu bar descriptions 68 have active segments operative to generate menus having items that when selected, invoke various processes related to the menu bar descriptions 68. By way of example only and not of limitation, the menu bar descriptions 68 may include “File,” “Edit,” “View, ” .Document,“” “Window,” and “Help.” Those having ordinary skill in the art will recognize the menu bar descriptions 68 and what processes may be initiated from the menus related thereto.

Below the menu bar 66 is a tool bar 70 with tool bar icons 74. The tool bar icons 74 also have active segments that are operative to initiate a data processing procedure. Some of these procedures include opening files, saving changes made to the currently loaded file, and so forth. Additionally, the tool bar icons 74 may be operative to alter the behavior of mouse clicks and drags on the workspace window 40, such as where one of the annotation selection icons 74a-74m is selected. It will be understood that “annotation selection icons,” is a general term, and are more particularly defined as free text icon 74a, note icon 74b, pen icon 74c, highlight icon 74d, line icon 74e, polyline icon 74f, callout icon 74g, lead line icon 74h, rectangle icon 74i, circle icon 74j, polygon icon 74k, cloud icon 74l, and image icon 74m. More particularly, clicking on one of the annotation selection icons 74a-74m and then clicking the left mouse button 38 with the cursor 36 somewhere on the workspace window 40 will place an annotation of the type indicated by the respective activated annotation selection icons 74a-74m thereon. In the particular example shown in FIG. 3, the callout icon 74g was selected, resulting in the placement of a first annotation 75. The aforementioned sequence of clicking the left mouse button 38 with the cursor 36 positioned on one of the annotation selection icons 74a-74m, repositioning the cursor 36 to a desired location on workspace window 40, and then clicking the left mouse button 38 will be understood to refer to the “using” or “placing” of an annotation. In this regard, any conventional method of placing an annotation on the workspace window 40 is deemed to be within the scope of the present invention. Examples of such methods alternative to that previously described include copying and pasting, importing annotations from other documents, and so forth.

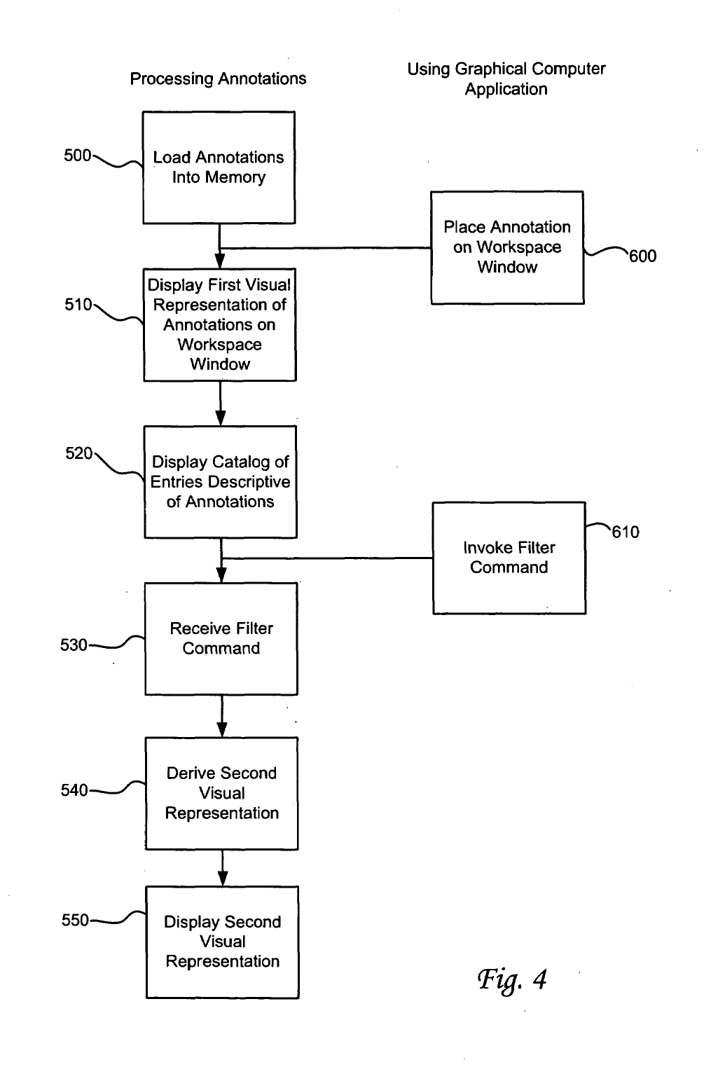

With the pertinent features of first output 34 common to all steps in the present invention being described above, the additional steps involved in the inventive methodologies will now be described in relation to the flowchart of FIG. 4. The left hand column of the flowchart describes the method of processing annotations, and the right hand column of the flowchart describes a method of using a graphical computer application. Additionally, the flowchart depicts the two methodologies and the interrelatedness thereof. The step 600 of placing the annotations on the workspace window is in accordance with the techniques described above, and step 500 includes the loading of the annotations into the memory 30, and will typically be preceded by the retrieval of the document 44 and the annotations associated therewith from the hard drive 28.

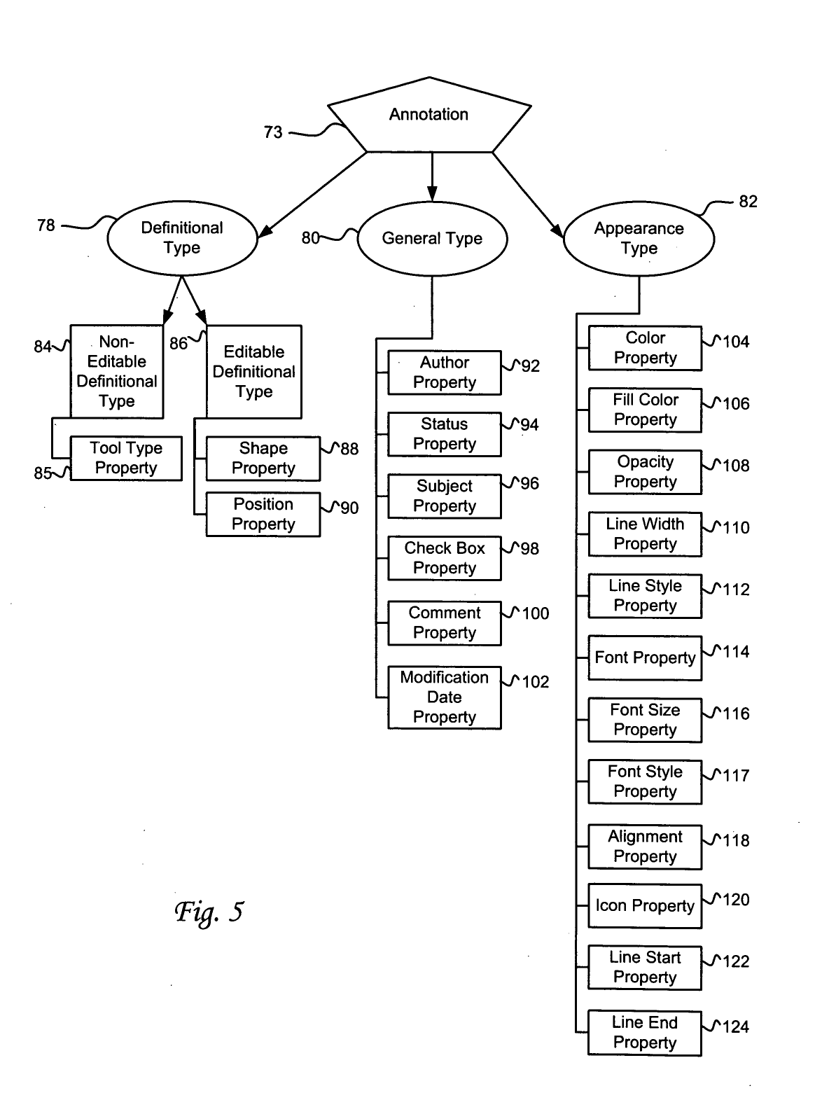

Referring now to FIG. 5, the hierarchical organization of a generic, exemplary annotation 73 will be described, and it will be understood that the details of a given annotation will be similar to another, except for the particular values of the properties. It will be further understood that any appropriate data structure may be utilized to store the annotations in the memory 30 without departing from the scope of the present invention. As those having ordinary skill in the art will recognize, the exemplary data structure may be considered similar to an object having multiple variables or a record with multiple fields. The annotation 73 is defined by one or more properties, each having a value. The properties can be categorized as definitional types 78, general types 80, and appearance types 82. It is understood that the categories are presented for purposes of simplification only, and are arbitrary in that data relating to such categories are not identified by the program. With regard to definitional types 78, further subcategories thereof include non-editable definitional types 84 and editable definitional types 86.

A non-editable definitional type 84 property is a tool type property 85, which defines the kind of annotation being defined. Possible values of the tool type property 85 correspond to the type of annotation, and also correspond to the toolbar icons 74a-74m. By way of example only and not of limitation, the value of the tool type property 85 may be “free text,” “note,” “pen,” “highlight,” “line,” “callout,” “leader line,” “rectangle,” “circle,” “polygon,” “cloud,” and “image,” or any other suitable annotation type capable of being placed on the workspace window 40. As used henceforth, the term “annotation type” refers to the annotations having a certain value of the tool type property 85. Thus, as an example, when referring to a “line type annotation” or other variations of such a designation, it will be understood to refer to an annotation having a tool type property 85 with the value of “line.” The tool type property 85 is deemed to be a non-editable type due to the fact that once the annotation 73 is placed on the workspace window 40 and assigned an initial value that cannot be subsequently changed.

The editable definitional types 86 of properties include a shape property 88 and a position property 90. The shape property 88 and the position property 90 are deemed editable because the value of these properties can be modified once the annotation 73 is placed on the workspace window 40 unlike the tool type property 85. More particularly, the shape property 88 includes values that define the points, lines, curves, and the like of the annotation 73 as it appears on the workspace window 40. The values of the shape property 88 are the parameters by which the program will draw the annotation 73 on the workspace window 40. Accordingly, the numerical value of the shape property 88 is specific to a given value of the tool type property 85. The user may indirectly modify the shape property 88 by visually changing the annotation 76 on the workspace window 40. Regarding the position property 90, the values thereof define the position of the annotation 73 with respect to the document 44 or the workspace window 40, and may include page numbers or coordinates. The position property 90 is indirectly modified by selecting the annotation 73 on the workspace window 40 and moving it to a different location. As is apparent, the properties of the definitional types 86 are only editable via interaction with the workspace window 40, and not via interaction with the markup window 42 or the properties window 43.

Next, turning to the general types 80, included within this category are an author property 92, a status property 94, a subject property 96, a checkbox property 98, a comment property 100, and a modification date property 102. The author property 92 defines the creator of the annotation 73. The default value of the author property 92 is the username associated with the system account utilized to create the annotation 73. The status property 94 has a finite list of values, including “accepted,” “rejected,” “cancelled,” and “completed,” but need not be limited to such values. The subject property 96 names the annotation 73, and multiple annotations may, and will typically have, the same subject property 96. The default value is equivalent to the value of the tool type property 85. Next, the checkbox property 98 is a Boolean value having a checked (on) state and an unchecked (off) state. Although a variety of uses for the checkbox property 98 is possible, a typical use is to determine whether the reviewer has examined the annotation 73. The comment property 100 contains text values which may or may not be displayed in the workspace window 40, depending upon the annotation type. The annotations which will incorporate the value of the comment property 100 when displayed on the workspace window 40 include those annotation types of free text, callout, and leader line. The value of the modification date property 102 represents the date and the time the annotation 73 was last edited. Editing includes the alteration of any of the properties of the annotation 73, including such modifications resulting from moving the annotation 73 within the workspace window 40.

Properties categorized as appearance types 82 include a color property 104, a fill color property 106, an opacity property 108, a line width property 110, a line style property 112, a font property 114, a font size property 116, a font style property 117, an alignment property 118, an icon property 120, a line start property 122, and a line end property 124. As will be understood by those having ordinary skill in the art, the color property 104 defines the color of all line segments of the annotation 73, while the fill color property 106 defines the color of any enclosed segments of the annotation 73. The opacity property 108 defines the level of opacity, or the degree of visibility provided through the annotation 73. Further, the line width property 110 defines the thickness of any line segments related to the annotation 73, while the line style property 112 indicates whether the line segments of the annotation 73 include gaps and if so, the size of such gaps. In other words, various dashed line styles may be specified with the line style property 112. The font property 114 defines the font in which to render any applicable text, the font size property 116 defines the size of such rendering, and the font style property 117 defines the bolding or italicizing of the rendered text The alignment property 118 indicates whether applicable text is to be left justified, right justified, or centered. The icon property 120 defines a graphic placeholder of the annotation 73. The line start and line end properties 122 and 124 define the types of arrowheads appended to a line segment of the annotation 73. While all of the aforementioned properties of the definitional and general types 78 and 80 are associated with every annotation, not all properties of the appearance type 82 are so associated. For example, because there is no text being displayed with respect to a line annotation type, such annotation will not include the font property 114, the font size property 116, the font style property 117 or the alignment property 118. Other such examples exist, but will be readily determined without detailed explanations thereof by one of ordinary skill in the art. Nevertheless, all annotation types include the color property 104, and its importance will become further evident below.

Referring back now to the flowchart of FIG. 4, the method of processing annotations further includes step 510 of displaying a first visual representation of all annotations in the memory 30 on the workspace window 40. As discussed in detail above, every annotation includes multiple properties that define the visual appearance of each annotation on the workspace window 40. In the particular exemplary first output 34 of FIG. 3, the first annotation 75 is a callout type of annotation, and is positioned on page 1 of the document 44 in the workspace window 40. The first annotation 75 also includes a comment text of “contents.” It is understood that the values of properties defining the first annotation 75 are employed in generating the first visual representation thereof. As used herein, the term “visual representation” refers to an appearance of a given annotation as generated on the workspace window 40.

Next, per step 520, the method includes displaying in the markup window 42 a catalog of entries that are descriptive of the annotations loaded in the memory 30. In the particular exemplary first output 34 of FIG. 3, the catalog generally corresponds to the table 48, and the entries generally correspond to the rows 50 of the table 48. In this regard, any suitable information representation system may be readily substituted for the catalog without departing from the scope of the present invention. The content of the column headers 54 correspond to one of the properties as described with reference to the diagram of FIG. 5. Further, the columns 52 contain values relating to the properties of the respective column headers 54, and the rows 50 contain information relating to the annotations loaded in the memory 30. By way of example only and not of limitation, column 52a contains values relating to the subject property 96. Accordingly, the corresponding column header 54a reads “subject.” The same relationship between a given column, column header, and property applies to the remaining columns 52b-52h, column headers 52b-52h, and the respective properties. It will be understood that the present invention is not limited to the particular columns, column headers, and properties, or the particular order of such columns and column headers as illustrated in FIG. 3, and additional properties may be included in the table 48. Referring back to the exemplary first output 34, the first annotation 75 is a callout type of annotation, and is positioned on page 1. The first annotation 75 has been “accepted,” and is not checked. The author is “RLEE”, and the date in which the first annotation 75 was last modified was 3/20/06. Further, first annotation 75 has a particular color value, and includes a comment text of “contents.” These values are depicted as a first entry 76 in the table 48, separated into the respective columns 52.

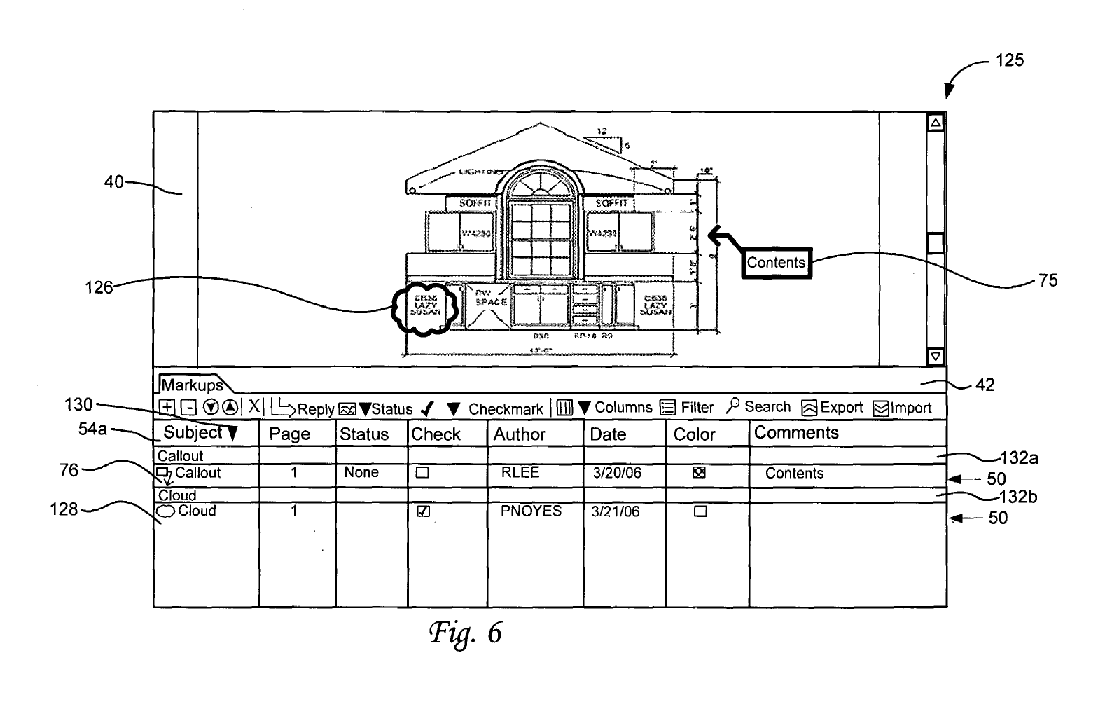

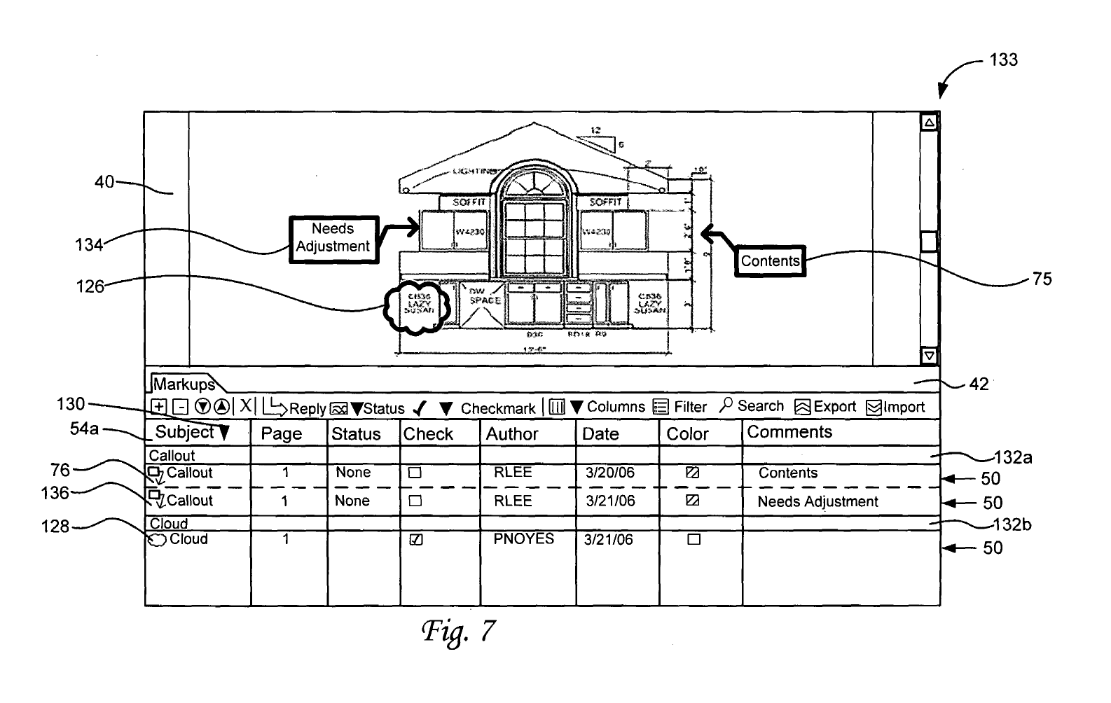

With reference to a second output 125 of FIG. 6, which omits certain details relating to the interface that have been previously discussed, the grouping functionality will now be described. A second annotation 126 of the cloud annotation type has been added, and a corresponding second entry 128 is depicted on the markup window 42 in the same manner as described in relation to the first entry 76. The second entry 128 is displayed upon placement of the second annotation 126 on the workspace window 40. As shown in the column header 54a, a grouping indicator 130 is displayed to the immediate right of the text, which signifies that the rows 50 are grouped in accordance with the property associated with the column header 54a, in this case, the subject property 96. In order to activate the grouping, the cursor 36 is navigated to the desired one of the column headers 54 and clicked. Thereafter, a first and second grouping bars 132a and 132b become interspersed between the rows 50, separating one grouping from another. In this regard, it will be understood that a distinctive grouping bar is generated for every value of the property that the rows 50 are being grouped by. Thus, in the example of FIG. 6, the first annotation 75 has a subject property 96 value of “callout” and the second annotation 126 has a subject property 96 value of “cloud.” Accordingly, the first grouping bar 132a corresponds to the “callout” per the first value of the subject property 96 and the second grouping bar 132b corresponds to the “cloud” per the second value of the subject property 96. Referring now to FIG. 7 and a third output 133, with the addition of a third annotation 134, there is generated on the markup window 42 a third entry 136. The third annotation 134 is a callout annotation type. With the entries being grouped according to the subject property 96, as evidenced by the grouping indicator 130 being generated adjacent to the subject column header 54a, the third entry 136 is grouped with the first entry 76 under the first grouping bar 132a. This is because the values of the subject property 96 are equivalent as between the first annotation 75 and the third annotation 134. It will be appreciated by one of ordinary skill in the art that entries may be grouped according to any property by selecting the desired property described in the respective column headers 54.

Referring back to FIG. 3, while individual values depicted in the table 48 may be directly edited through the same, the properties window 43 also provides editing functions. As explained above, every annotation type has every property of the general type 80, including the author property 92, the status property 94, the subject property 96, the checkbox property 98, and the comment property 100. For the purpose of improving usability, those properties envisioned to be edited primarily on an individual, annotation-by-annotation basis are editable through the properties window 43. These properties include the author property 92, the subject property 96, and the comment property 100, and are depicted with appropriate input boxes 58 with corresponding property descriptors 56 in the properties window 43. Further, although not visible, properties of the appearance type 82 are also capable of being edited through the properties window 43. On the other hand, those properties intended to be edited primarily in the course of examining multiple annotations at once, such as the status property 94, and the checkbox property 98, are only editable through the markup window 42.

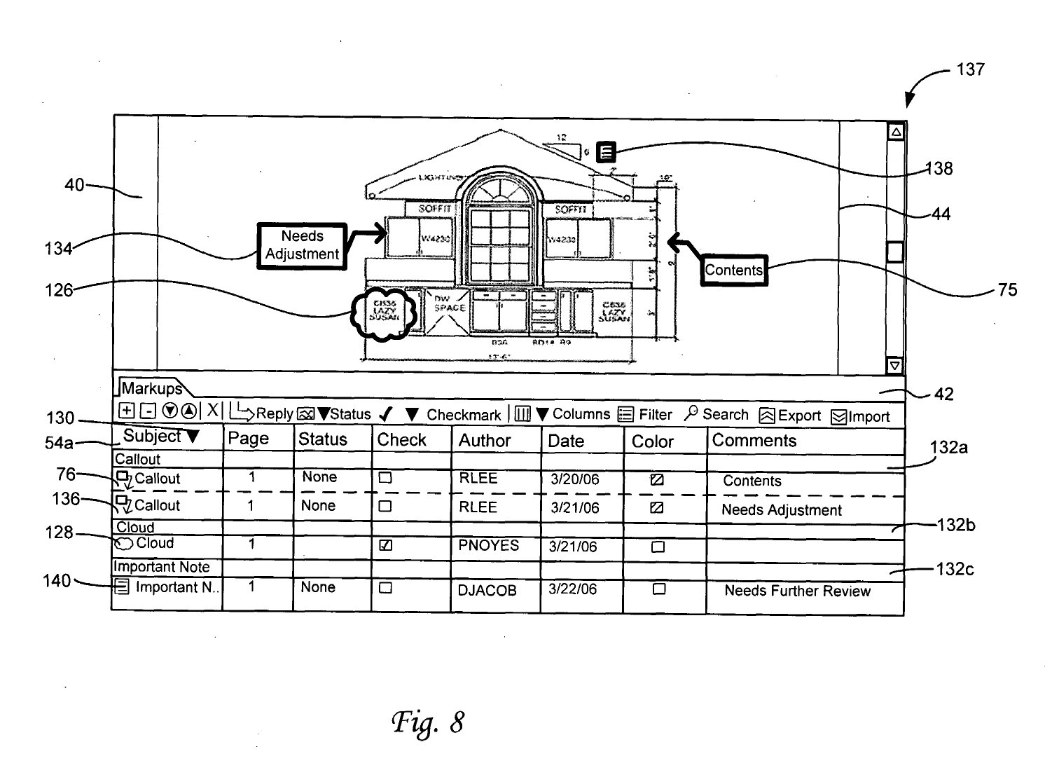

Referring to the flowchart of FIG. 4, the method of using a graphical computer application includes the step 610 of invoking a filter command. Further, the method of processing annotations includes the step 530 of receiving the filter command. The filter command may specify a condition, and is operative to derive an included annotation set and an excluded annotation set. Generally, the filter command refers to the selection of a certain property and a value thereof to filter for. The selected property and the value thereof is the condition by which the excluded annotation set and the included annotation set is determined. An exemplary implementation of this step will be described in further detail with reference to a fourth output 137 of FIG. 8. As illustrated, a fourth annotation 138 of a note annotation type is added to the document 44, and a corresponding fourth entry 140 is added to the markup window 42 and grouped under a third grouping bar 132c. As was the case in FIG. 7, the table 48 is grouped according to the subject property 96. The fourth output 137 depicts the output of the program just before that of performing step 530, with first visual representations of the first annotation 75, the second annotation 126, the third annotation 134, and the fourth annotation 138 being displayed on the workspace window 40, and the first entry 76, the second entry 128, the third entry 136, and the fourth entry 140 displayed on the table 48 on the markup window 42.

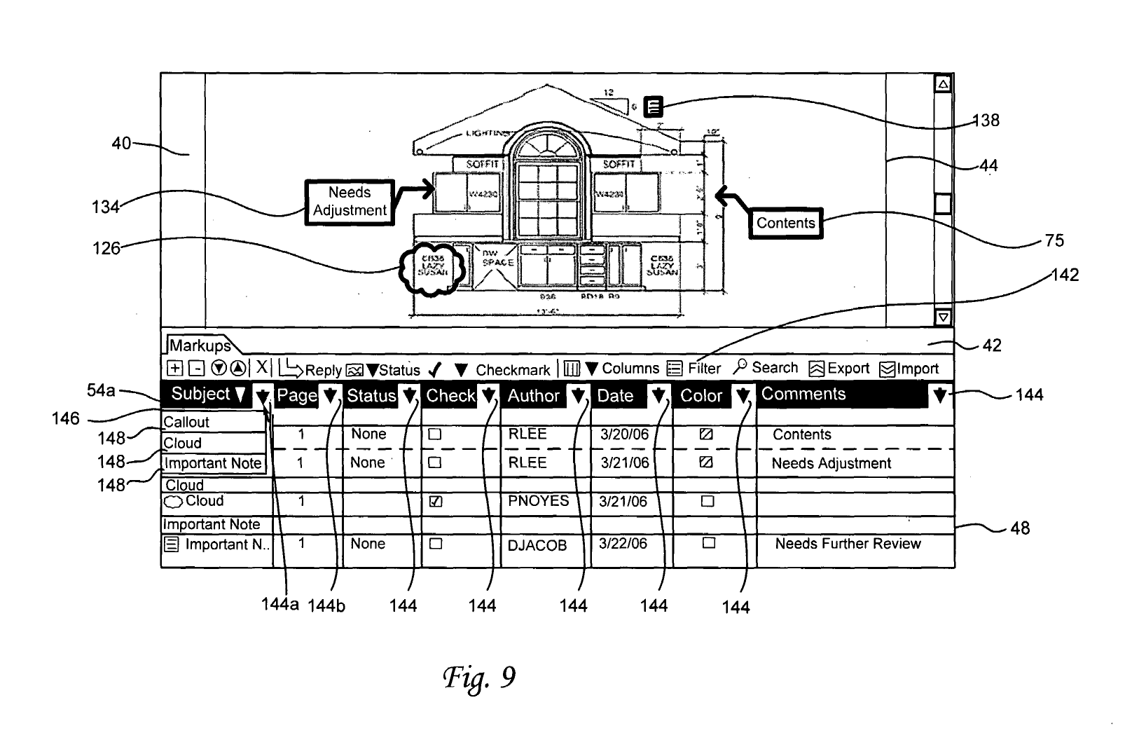

With reference to FIG. 9, the filter command is activated by first clicking on a filter modifier icon 142 on the markup window 42. This is operative to alter the appearance of the column headers 54, for purposes such as alerting the user to the fact that some entries otherwise in existence and stored in memory 30 are not being displayed in the table 48, or that the next step in activating the filter command is possible. Concurrently, pull down arrows 144 are generated in each of the column headers 54. By clicking on the first pull down arrow 144a, a value selection window 146 is overlaid above the markup window 42. The value selection window 146 includes a selectable listing of elements 148 representative of values of the particular property associated with or contained within the column, which in the exemplary illustration of FIG. 9 is the subject property 96. The elements 148 listed in the value selection window 146 are all values of the subject property 96 which define annotations loaded in the memory 30, which are “callout,” “cloud,” and “Important Note.” By clicking on one of the elements 148, the filter command is invoked with a value of a selected one of the elements 148 as the condition. Multiple conditions can be specified by clicking a second pull down arrow 144b and selecting another element listed in a window similar to the value selection window 146. In this regard, the conditions may be comprised of multiple sub-conditions that may be individually specified through multiple selections of the elements 148 across multiple properties as described. The sub conditions may be combined with any one of Boolean operators, including AND, OR, or NOT. In the preferred embodiment, however, the sub-conditions will be combined using the AND operator, to obtain results that will include only those annotations having property values matching specified by all of the sub-conditions.

By way of example only and not of limitation, assuming that the subject property 96 having the value “callout” was selected in the value selection window 146, the included annotation set will include those annotations being defined by the subject property 96 with the value “callout,” namely, the first and third annotations 75 and 134, respectively. Further, those annotations of the excluded annotation set will be the remaining annotations having other values of the subject property 96, such as “cloud” or “Important Note,” namely, the second and fourth annotations 126 and 138, respectively.

After applying the filter to yield the included annotation set and the excluded annotation set, according to step 540, the method includes deriving a second visual representation of each of the annotations of the excluded annotation set. The excluded annotation set is comprised of the second and fourth annotations 126 and 138. Then, according to step 550, such second visual representations of those annotations of the excluded annotation set are displayed on the workspace window 40. In another embodiment, the method may include deriving a second visual representation of each of the annotations of the included annotation set. The included annotation set is comprised of the first and third annotations 75 and 134.

It is understood that the operations of derivations involving the annotations of the included annotation set are different from the operations of derivations involving the annotations of the excluded annotation set. Particularly, the operations upon annotations of the excluded annotation set are intended to fade the annotations into the background, while the operations upon annotations of the included annotation set are intended to highlight the annotations from the others.

As will be apparent to one of ordinary skill in the art, modifications made to the first visual appearances of the annotations displayed on the workspace window 40 are intended to be temporary, in that once the filter condition is eliminated, the first visual appearances will return. However, in outputting the document 14 to a printer, an option for retaining the second visual appearances of the annotations is selectable.

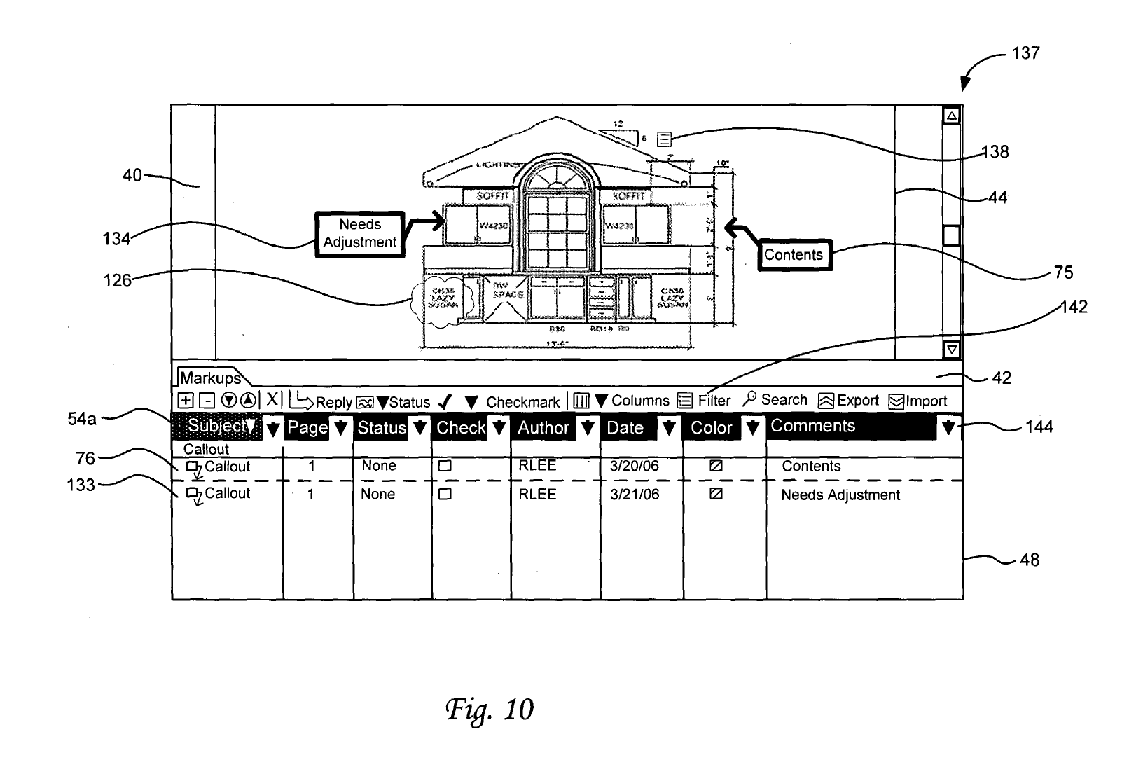

Having considered the processing of annotations in abstract terms such as the included annotation set and the excluded annotation set, the methodology will be discussed in more tangible terms with reference to FIG. 10. The condition specified by the filter command in selecting the subject property 96 with the particular value of “callout” as described above was essentially operative to highlight those annotations having a subject property 96 of “callout,” i.e., the first annotation 75 and the third annotation 134. From a different perspective, the filter was effective to fade the second annotation 126 and the fourth annotation 138 into the background of the workspace window 40. As illustrated by FIGS. 9 and 10 and differences therebetween, the filter command was effective to change the first visual appearances of second annotation 126 and fourth annotation 138. Whereas in FIG. 9, the line widths of second annotation 126 and fourth annotation 138 are depicted as equivalent to that of the first annotation 75 and the third annotation 134, the line widths of second annotation 126 and fourth annotation 138 are substantially decreased in FIG. 10. One of ordinary skill in the art will recognizes that while depicted in terms of line widths, any suitable property contributing to the appearance of the annotations may be substituted without departing from the scope of the present invention.

As discussed above with reference to FIG. 5, all of the annotations have associated therewith properties of the appearance type 82. In this regard, the appearance type 82 property may have an initial value that is transformed into a resulting value for converting from the first visual representation to the second visual representation. Also as discussed above, every annotation includes a color property 104, and therefore it is suited for use as an appearance type 82 property capable of affecting the second visual representation of every annotation type.

In a preferred embodiment, the color property 104 is converted from a full color to a grayscale value, and the grayscale value is adjusted by a predetermined amount. Any of the techniques well known in the art may be utilized to convert to the grayscale value, as well as to adjust the grayscale value. It is preferred that a percentage of the grayscale value be subtracted such that the visual representation appears lighter or darker, but may also be adjusted to an absolute value. Further, the brightness of the grayscale value may be adjusted within the range of 0% for completely fading into the background, and 100% for full visibility. It is understood that the adjustment percentages are modifiable by the user. While the adjustments to the visual appearances of annotations in general have been discussed, the application of similar techniques for adjusting the appearance of the graphic elements 46 is deemed to be within the scope of the present invention.

With respect to the markup window 42 illustrated in FIG. 10, following the invocation of the filter command and reloading the table 48, entries relating to the annotations of the excluded annotation set, particularly the second annotation 126 and the fourth annotation 138, are removed, retaining only those annotations of the included annotation set. As shown in FIG. 10, only the first entry 76 and the third entry 136 are present. Furthermore, since the property selected as the filter condition is the subject property 96, the column header 54a relating to the same is displayed with an alternate appearance as an indication of this fact. Upon clearing the filter, the other entries relating to the annotations of the excluded annotation set will again become visible in the markup window 42.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method of processing annotations associated with a document having graphic elements overlaid on a background, the annotations and the document being displayed on an output device of a data processing device having a memory, the method comprising:
loading a plurality of annotations into the memory, each annotation being defined by properties;
displaying in a workspace window a first visual representation of each of the annotations loaded in the memory as defined by the properties;
displaying in a markup window a catalog having entries descriptive of the annotations loaded in memory, the entries depicting values of the properties defining the annotations;
receiving a filter command which specifies a condition, the filter command being operative to derive an included annotation set and an excluded annotation set, the included annotation set being defined by those annotations with properties matching the condition, the excluded annotation set being the plurality of annotations less the included annotations;
deriving a second visual representation of the each of the annotations of the excluded annotation set different from the first visual representations of the annotations of the excluded annotation set; and
displaying in the workspace window each of the second visual representations of the annotations of the excluded annotation set.

2. The method of claim 1, further comprising the step of:
refreshing the markup window with the entries descriptive of the annotations of the excluded annotation set being removed from the catalog.

3. The method of claim 1 wherein multiple sub-conditions comprise the condition

4. The method of claim 1 wherein at least one of the properties defining the annotations is an appearance type property, the appearance type property having a first value while displaying the first visual representation of the annotation of the excluded annotation set, the deriving step further comprising:
transforming the first value of the appearance type property into a second value.

5. The method of claim 1, further comprising the steps of:
generating a corresponding grayscale representation of the graphic elements, the grayscale representation including a brightness component; and
modifying the brightness component of the grayscale representation to fade the grayscale representation of the graphic elements into the background.

6. The method of claim 1, further comprising the steps of:
deriving a second visual representation of each of the annotations of the included annotation set different from the first visual representation of each of the annotations of the included annotation set; and
displaying in the workspace window each of the second visual representations of the annotations of the included annotation set.

7. The method of claim 6 wherein at least one of the properties defining the annotations is an appearance type property, a first appearance type property defining each of the annotations of the excluded annotation set, and a second appearance type property defining each of the annotations of the included annotation set.

8. The method of claim 7 wherein the first appearance type property has an initial first value while displaying the first visual representation of the respective annotation of the excluded annotation set, the step of deriving the second visual appearance of the respective annotation of the excluded annotation set further comprising:
transforming the initial first value into a resultant first value.

9. The method of claim 8 wherein the second appearance property has an initial second value while displaying the first visual representation of the respective annotation of the included annotation set, the step of deriving the second visual appearance of the respective annotation of the included annotation set further comprising:
transforming the initial second value into a resultant second value.

10. The method of claim 9 wherein the transforming step of the initial first value is different from the transforming step of the initial second value.

11. The method of claim 9 wherein the first appearance type property defines a color and the initial first value is representative of the color, the transforming step of the initial first value further includes the steps of:
converting the initial first value of the color to a corresponding grayscale value; and
adjusting the grayscale value to a resultant first value.

12. The method of claim 11 wherein the resultant first value is preset.

13. The method of claim 11 wherein the grayscale value is adjusted by a preset number.

14. The method of claim 1, further comprising the step of:
grouping the entries of the catalog according to one of the properties of the respective one of the annotations loaded in the memory; and
generating a grouping header in the catalog, the grouping header being representative of one of the properties of the annotation by which the entries are being grouped.

15. The method of claim 1 wherein the catalog is a table having a plurality of rows and columns, each column being related to one of the properties of the annotations and each row being related to one of the annotations.

16. The method of claim 15 wherein the table includes a column header for each column, a first column header being descriptive of the property contained in a first column, the method further comprising the step of:
displaying in the vicinity of the first column header a first value selection window including a first listing having first elements representative of each of the values of the property contained in the first column.

17. The method of claim 16 wherein the filter command is triggered by a selection of one of the first elements of the first listing, the first value of the selected first element being a first sub-condition comprising the condition by which the included annotation set is defined.

18. The method of claim 17 wherein a second column header is descriptive of the property contained in a second column, the method further comprising the step of:
displaying in the vicinity of the second column header a second value selection window including a second listing having second elements representative of each of the values of the property contained in the second column;
the filter command being triggered by a selection of one of the second elements of the second listing, the second value of the selected second element being a second sub-condition comprising the condition by which the included annotation set is defined, the first sub-condition and second sub-condition being combined to form the condition.

19. A method of using a graphical computer application, the method comprising the steps of:
placing a plurality of annotations on a workspace window, each of the annotations being defined by properties and having a first visual appearance; and
invoking a filter command on a markup window to specify a condition, the filter command being operative to derive an included annotation set and an excluded annotation set, the included annotation set being defined by those annotations with properties matching the condition, the excluded annotation set being the plurality of annotations less the included annotations, the filter command being further operative to display a second visual representation of each of the annotations of the excluded annotation set different from the first visual representations of the annotations of the excluded annotation set.

20. The method of claim 19, wherein the filter command is operative to display a second visual representation of the annotations of the included annotation set different from the first visual representation of each of the annotations of the included annotation set.

21. An article of manufacture comprising a program storage medium readable by a data processing apparatus including a memory and an output device, the medium tangibly embodying one or more programs of instructions executable by the data processing apparatus to perform a method of processing annotations associated with a document having graphic elements overlaid on a background, the method comprising:
loading a plurality of annotations into the memory, each annotation being defined by properties;
displaying in a workspace window a first visual representation of each of the annotations loaded in the memory as defined by the properties;
displaying in a markup window a catalog having entries descriptive of the annotations loaded in memory, the entries depicting values of the properties defining the annotations;
receiving a filter command which specifies a condition, the filter command being operative to derive an included annotation set and an excluded annotation set, the included annotation set being defined by those annotations with properties matching the condition, the excluded annotation set being the plurality of annotations less the included annotations;
deriving a second visual representation of the each of the annotations of the excluded annotation set different from the first visual representations of the annotations of the excluded annotation set; and
displaying in the workspace window each of the second visual representations of the annotations of the excluded annotation set.

22. The article of manufacture of claim 22, the method further comprising the step of:
deriving a second visual representation of each of the annotations of the included annotation set different from the first visual representation of each of the annotations of the included annotation set; and
displaying in the workspace window each of the second visual representations of the annotations of the included annotation set.
